(19) United States
(12) Patent Application Publication
(10) Pub. No.: US 2003/0140229 A1
(43) Pub. Date: Jul. 24, 2003

(54) Method and device for verifying a file

(76) Inventor: Kersten W. Heins, Freising (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/168,133

(22) PCT Filed: Dec. 21, 2000
(86) PCT No.: PCT/EP00/13122

(30) Foreign Application Priority Data
Dec. 21, 1999 (DE) 199 61 838.0

(51) Int. Cl. H04L 9/00

(52) U.S. Cl. 713/176

(57) ABSTRACT

A method for verifying the authenticity and integrity of a file which has been received or is to be transmitted by a computer (14) and which is provided with a digital signature, accesses for verification signals which are available at an interface (18) of the computer with an output device (16) for outputting the file provided with the digital signature. A device (20) for carrying out the method according to the invention comprises a circuit and a program which are used to perform the verification in the device (20) and in a manner logically separate from the central calculating unit of the computer (14), the device (20) being coupled to an interface (18) of the computer (14) with an output device (16) in such a way that it detects the signals used for the verification for outputting the file provided with the digital signature.

The invention relates to a method for verifying the authenticity and integrity of a file which has been received or is to be transmitted by a computer and which is provided with a digital signature. The invention further relates to a device for carrying out the method.

The transmitting and receiving of data by electronic ways and means has become enormously important with the progressive development of the Internet. Particularly in the interchange of important data (sensitive data), as occurs for instance with trading via Internet (e-commerce), there is the need of guaranteeing a safe data transmission. This results from the fact that information that is sent via the Internet from one computer to a remote, other computer, passes through a number of interposed computers and separate networks before it arrives at its destination. Thus, there is the danger that the transmission of data by means of files may be disturbed in an undesired way prior to the reception thereof both due to transmission errors and also by a third party.

It is in particular the recipient of a transmitted file that is interested in that the. authenticity and integrity of the received file has been verified. Authenticity means in this context the guarantee that the file actually comes from that person (or from that company etc.) who pretends to be the sender of the file. The integrity of the file exists, if its content has not been altered—deliberately or accidentally—during transmission. With specific applications, there are the additional demands on the side of the recipient that the confidential nature of the transmitted data is ensured and/or that the denying by the sender of having sent the data is ruled out.

Safeguarding the data transmission taking into consideration the aspects as set out above is done in a known manner by using well-established technologies and standards which find international acceptance and are termed public key cryptography. An essential aspect of this method is to provide a file, which is to be transmitted, with a digital signature which is verified after reception of the “signed” file on the computer of the recipient. Thus, a signed file means in this context a file complete with its associated digital signature.

During verifying there is the danger, however, that specific viruses or other vicious programs (e.g. special Java or ActiveX applications etc.) in the computer of the recipient disturb the verification operations or have such an influence on these that the recipient does not notice that the data, output on the display screen of his/her computer, is not coincident with the data that has been sent. On the other hand, it is also possible that the verifying of the received data is performed in a correct manner and correctly leads to a positive result, but that manipulated data is output on the display screen without a warning for the recipient occurring.

The inverse problem can occur on the side of the sender of the file. If there occurs, on signing a file that is to be transmitted, a fault caused by a virus or the like and being not noticeable to the sender, the latter does not have the possibility to recognize the defect with the aid of the signed file displayed on the display screen, in particular in case there is a defect in the digital signature.

A solution to these problems would be possible with a completely independent signature architecture, i.e. with a special system that shielded from the environment is provided exclusively for the verification of files. However, as such a system would require a processor and peripheral devices of its own, such as a keyboard, a display screen etc., it is too costly for the intended purpose.

From U.S. Pat. No. 5,406,624 there is known a safeguarding device for a computer, with which data relevant to safeguarding is kept away from the computer which possibly is infected by a virus or the like. The device further serves the purpose to carry out operations such as the generation of keys and writing the keys into smart cards, in a manner independent from the computer. For this, the computer is isolated from its peripheral devices, by these being not directly connected with the computer, but via the interposed safeguarding device. For performing the operations that are relevant to safeguarding, the device takes the control over the peripheral devices and independently performs the required actions such as reading of or writing into a smart card. The safeguarding device, however, is not suitable for verifying the authenticity and integrity of a file that has been output at an output device of the computer, received online or that is to be transmitted. A further disadvantage of this device is that special instructions or a separate switch box is needed for its activation. In addition, the safeguarding device is very complicated and, hence, expensive, because it is designed for performing complex operations such as the reading of and writing into a smart card. Moreover, a complete and separate display screen control has to be present in the safeguarding device.

Therefore it is the object of the invention to provide a possibility of verifying a signed file that has been received or is ready to be sent, which makes available an information which is as safe as possible in terms of the authenticity and integrity of the file output at the output device of a computer.

This object is solved by a method of the type initially mentioned in which, for verification, signals are accessed which are available at an interface of the computer with an output device for outputting the file provided with the digital signature. This allows a verification of data as it is output at the output device of the computer and perceived by the user. The invention is based on the knowledge that the signals which are delivered to an output device of the computer, can not be attacked by viruses or the like, because the output device represents a passive unit which does not further process the data. Thus, the observer of the signed file can be informed of the fact whether the file output at the output device and the digital signature match each other. In case of a positive result, it is ensured in this way that the data (file and digital signature) brought in for verification has not been manipulated later on the computer of the recipient or in the network.

Since it is provided to carry out the method according to the invention in a device that is logically separate from the central calculating unit (CPU) of the computer, the verification of the file can not be disturbed by viruses or the like, which possibly have an influence on the data processing taking place in the computer.

The reconstruction of the file output at the output device and its digital signature from the signals available at the interface allows a comparatively uncomplicated verification of the output and signed file by using known methods.

The method according to the invention preferably comprises the decryption of the digital signature of the reconstructed signed file, a first digest number being generated by the decryption. This first digest number can then be compared in a simple way with a second digest number which is determined from the reconstructed file. The result of this comparison gives safe information about the authenticity and integrity of the file which is output, provided that the employed key actually belongs to the sender. However, this assigning between public key and sender usually is ensured by an independent certification authority. In addition, with a positive result of the comparison and if the. file concerned is a received file, the recipient can be sure that the file really has been sent by the sender. Consequently, for instance the sender can not make an offer meaningless that is contained in the file by denying to have ever sent this file.

According to a further development of the method it is also provided for to verify the point of time of generation of the file provided with the digital signature. It is in this way that, e.g. with received files, there can be given at the moment of receiving a safe information about the validity of an offer that is limited in time and was contained in the signed file.

The method according to the invention is particularly suitable for files that have been received online from a network or are transmitted online via a network, because such files are subject to an increased risk of faulty transmission or manipulation.

Finally it proves to be an advantage to carry out at least a part of the method by means of a chip card. In case the computer is equipped, for instance, with a smart card terminal, it is possible to support by an appropriate smart card both decryption operations necessary in connection with the method according to the invention, and verifications of keys.

The invention also makes provision of a device for carrying out the method according to the invention, which comprises a circuit and a program which are used to perform the verification in the device and in a manner logically separate from the central calculating unit of the computer, the device being coupled to an interface of the computer with an output device in such a way that it detects the signals used for the verification for outputting the file provided with the digital signature. With the device according to the invention, it is thus possible in an easy way to scan and evaluate the signals that are provided for the output of the signed file and that can not be attacked. Due to the device being separate from the data processing of the computer, verification of the file can not be disturbed either.

The device is coupled preferably to the interface of the computer with a display screen. In this way for instance the recipient of a file receives the safe information whether the received file in the form as is displayed on the display screen actually comes from the indicated sender and has been transmitted in an interference-free manner. The device, however, can also be coupled to the interface of the computer with a printer.

For a cost-effective production of the device it is of advantage that the device comprises an ASIC (application-specific integrated circuit), which houses the circuitry necessary for verification. The ASIC can also include a microprocessor which operates in a program-controlled manner.

Flexibility in terms of the selection of the computer on which the device is to be employed is achieved in that the device is suitable for retrofitting of the computer, i.e. is configured as a so-called add-on system. The device can be installed on the desired computer in a simple manner and, if required, be uninstalled again in order to equip another computer with the device. The device can be arranged internally on the base board (motherboard) of the computer or on a plug-in card of the computer. It can, however, also be realized in an external equipment which is connected with the computer. So it is possible, for instance, to integrate the device in a chip card terminal, e.g. a smart card reading/writing device. The device preferably includes a chip card which is assigned to the chip card terminal and is linked to the remaining device in such a way that it carries out a decryption process at least in part or provides data for a decryption process. Hence, there exists the possibility to have at least part of the method according to the invention carried out with the help of or directly by a microprocessor of the smart card. There are also further functions that are related to the method according to the invention which can be performed by the terminal.

In order to inform the user in a simple and uncomplicated manner about the result of the file verification, the device comprises a TRUE/FALSE display means.

A preferred embodiment of the device according to the invention comprises a real-time clock by means of which the age of a signed file can be determined. This may be required, for instance, to verify whether an offer contained in the file is still valid.

In case the device is to be installed at changing places, the coupling of the device to the interface of the computer can be effected in a wireless manner. With this, the selection of the locations is not impaired by the length of a cable or its undesired visibility.

Further features and advantages of the invention will be apparent from the following exemplary description with reference to the drawings in which:

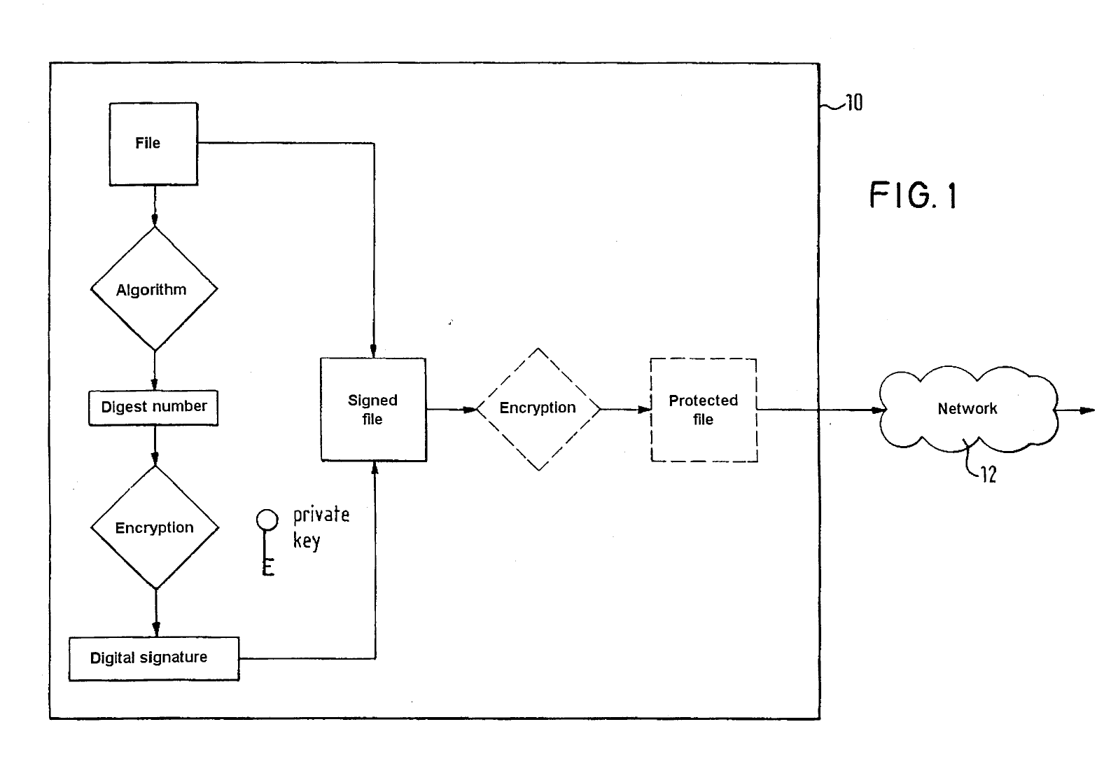

FIG. 1 shows a schematic flowchart for processing a file that is to be transmitted; and

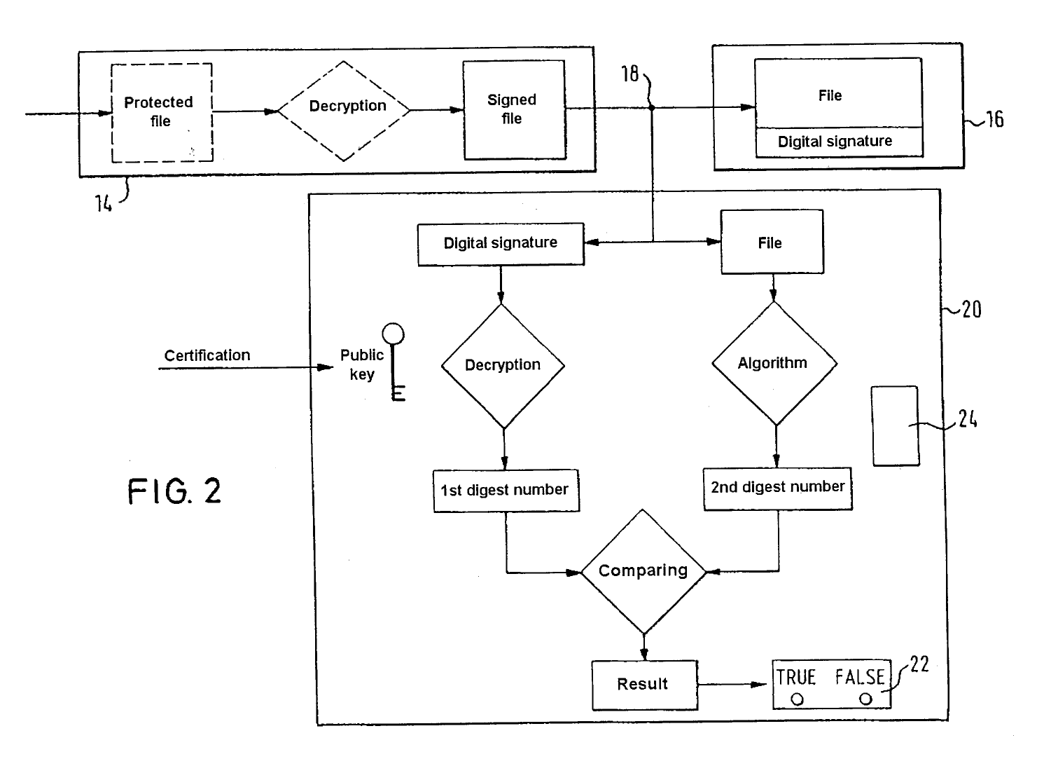

FIG. 2 shows a schematic flowchart for verifying a file which has been received using the device according to the invention, which operates in accordance with the method of the invention.

The method according to the invention and the device according to the invention as provided therefor will now be described below, with the aid of the example of verifying a file which has been received. It is, however, just as possible to apply the method and the device on the side of the recipient for verifying a file which is ready to be sent and available at the interface with the network.

FIG. 1 illustrates the operations which usually proceed in accordance with the concept of public key cryptography on a computer 10 of the sender prior to transmission of a file. By means of a given mathematical algorithm, a so-called digest number is calculated from the file prepared by the sender and to be sent to a recipient. A digest number has a given length and is specific to the particular file, i.e. even the slightest change in the file would result in a different value. On the other hand, however, it is impossible to ever obtain the original file from the digest number. The digest number of the file is encrypted by means of a private key of the sender, which is known only to the sender. The result of this encryption is referred to as digital signature of the file. The digital signature is appended to the file to be transmitted. The file provided with the digital signature (signed file) may now be sent immediately to the recipient via a network 12 or, if the data is confidential, may be encrypted beforehand.

The optional encryption of the signed file is usually performed by means of a randomly generated one time key. The one time key itself is, in turn, encrypted by a public key and subsequently appended to the signed, encrypted file. Finally, they are both sent together to the recipient as “protected file”.

FIG. 2 shows the operations carried out for verification of the received file on the side of the recipient. The file received by a computer 14 is recognized as protected file or merely as signed file. In the first case, the protected file is first decrypted on the computer 14 by means of a private key of the recipient, whereby a signed but still encrypted file and a one time key are obtained. Using the one time key, the signed, encrypted file may now be decrypted. The signed file resulting therefrom is subsequently processed further in the same way as a file which has been received non-encrypted and which is provided with a signature.

In order to make the signed file visible to the recipient, it is output at an output device 16 which is connected to the computer 14 via an interface 18. As a rule, the output device 16 is a display screen, but a printer or the like may for example also be provided. The signals supplied by the computer 14 to the output device 16 for displaying the signed file are logically separate from the central calculating unit of the computer 14, i.e. these signals can not be affected by programs running on the computer 14. Therefore, these signals are not subject to attack by viruses or the like, either.

In addition to the output device 16, further connected to the interface 18 is a device 20 which can access the signals intended for the output device 16. Normally, an interface 18 with a display screen is an analog interface. In modern display screens, which themselves convert the data to be displayed to analog signals, a digital interface is provided accordingly. For the sake of simplicity, the data available at the interface in this case is likewise referred to as “signals”. Both the connection of the output device 16 and of the device 20 with the interface 18 of the computer 14 may be effected in a wireless manner, e.g. by means of infrared interfaces, adapted to each other, provided at the equipment involved.

The device 20 includes an electronic circuit which may be accommodated in an ASIC, and a suitable program for verifying the signed file. Since the device 20 is logically separate from the central calculating unit of the computer 14, disturbance of the verification of the signed file by viruses or the like which are located for example in the main memory of the computer 14 and affect the data processing in an undesirable way is impossible.

The verification of the signed file in the device 20 will now be described for the case in which the output device 16 is a display screen: The signals available at the interface 18 are scanned and evaluated by the device 20. The image output on the display screen may thereby be reconstructed and the file “displayed” therein along with the associated digital signature is located. The digital signature is decrypted by means of a public key which has been made publicly accessible by the sender and is adapted to the private key which was used to encrypt the digest number generated from the original file by the sender. The public key is certified by an independent certification authority. The result of such decryption is a first digest number. A second digest number is calculated from the file itself. For this the same mathematical algorithm is used which generated the original digest number on the computer 10 of the sender. The information about the mathematical algorithm required for this process have been sent together with the digital signature. The two digest numbers are eventually compared with each other and the result is output via a TRUE/FALSE output means 22 of the device 20. The result may be displayed for example by a green light-emitting diode in the case of concurrent digest numbers (TRUE) and by a red light-emitting diode in case the digest numbers are not concurrent (FALSE).

If the two digest numbers concur, the file was not altered after the signing by the sender. Moreover, the recipient can be certain as regards the identity of the sender since the certification of the public key ensures the association thereof with the sender. Since the sender has sole access to the private key which was used for signing the file, the sender can also not deny having sent the file. When the two digest numbers do not concur, it must be assumed that the file was either not correctly transmitted or was tampered with, or that the signature was generated using a private key that does not match the public key used for the decryption of the digital signature.

A preferred embodiment of the device 20 additionally comprises a real-time clock 24 for a reliable determination of the age of the file, e.g. the time difference between the points of time of reception and generation of the file. For this purpose, prior to sending, apart from the digital signature, the file is provided with an indication of the point of time of generation or sending or the period of validity which may be referred to as time stamp. It can now be determined in the device 20 by a comparison of this time indication with the current time whether, e.g., an offer limited in time which is contained in the file is still valid. This verification is then also taken into consideration when the result of the verification of the file is displayed.

The device 20 is designed as an add-on system, i.e. a computer may be retrofitted with the device 20. In so doing, the device 20 may be disposed either internally within the computer 14 on the base board or on a plug-in card. In accordance with a further embodiment, the device 20 is integrated in a smart card terminal. With the aid of the smart card terminal and an appropriate smart card the certification of the public key required for the decryption of the digital signature may be verified at the same time. Furthermore, the decryption of the digital signature or, if applicable, of the protected file may be assisted by a suitable smart card. The smart card includes, for example, a key necessary for the respective decryption and/or a decryption program. The entire decryption or a part thereof can be performed or controlled by a microprocessor of the smart card.

1. A method for verifying the authenticity and integrity of a file which has been received or is to be transmitted by a computer (10; 14) and which is provided with a digital signature, characterized in that for verification, signals are accessed which are available at an interface (18) of the computer (10; 14) with an output device (16) for outputting the file provided with the digital signature.

2. The method according to claim 1, characterized in that the method is carried out in a device (20) logically separate from the central calculating unit of the computer (10; 14).

3. The method according to claim 1 or 2, characterized in that the method comprises the reconstruction, from the signals available at the interface, of the file output at the output device (16) and provided with the digital signature.

4. The method according to claim 3, characterized in that the method comprises the decryption of the digital signature of the reconstructed signed file, a first digest number being generated by the decryption.

5. The method according to claim 4, characterized in that the method comprises determining a second digest number from the reconstructed file and comparing the first digest number with the second digest number.

6. The method according to any of the preceding claims, characterized in that the method comprises verifying the point of time of generation of the file provided with the digital signature.

7. The method according to any of the preceding claims, characterized in that the file provided with the digital signature was received online from a network or is transmitted online via a network.

8. The method according to any of the preceding claims, characterized in that at least a part of the method is carried out by means of a chip card.

9. A device for carrying out the method according to any of the preceding claims, characterized in that the device (20) comprises a circuit and a program which are used to perform the verification in the device (20) and in a manner logically separate from the central calculating unit of the computer (10; 14), and that the device (20) is coupled to an interface (18) of the computer (10; 14) with an output device (16) in such a way that it detects the signals used for the verification for outputting the file provided with the digital signature.

10. The device according to claim 9, characterized in that the device (20) is coupled to the interface (18) of the computer (10; 14) with a display screen.

11. The device according to claim 9, characterized in that the device (20) is coupled to the interface (18) of the computer (10; 14) with a printer.

12. The device according to any of claims 9 to 11, characterized in that the device (20) comprises an ASIC.

13. The device according to any of claims 9 to 12, characterized in that the device (20) is suitable for retrofitting of the computer (10; 14).

14. The device according to any of claims 9 to 13, characterized in that the device (20) is arranged on the base board of the computer (10; 14).

15. The device according to any of claims 9 to 13, characterized in that the device (20) is arranged on a plug-in card of the computer (10; 14).

16. The device according to any of claims 9 to 13, characterized in that the device (20) is integrated in a chip card terminal.

17. The device according to claim 16, characterized in that the device (20) includes a chip card which is assigned to the chip card terminal and is linked to the remaining device in such a way that it carries out a decryption process at least in part or provides data for a decryption process.

18. The device according to any of claims 9 to 17, characterized in that the device (20) comprises a TRUE/FALSE display means.

19. The device according to any of claims 9 to 18, characterized in that the device (20) comprises a real-time clock (22).

20. The device according to any of claims 9 to 19, characterized in that the coupling of the device (20) to the interface (18) of the computer (10; 14) is effected in a wireless manner.
